(19) United States
(12) Patent Application Publication
(10) Pub. No.: US 2023/0307839 A1
(43) Pub. Date: Sep. 28, 2023

(54) Base Station

(71) Applicant: Telefonaktiebolaget LM Ericsson (publ), Stockholm (SE)

(72) Inventors: Xuejun Sun, Beijing (CN); Liang Wang, Beijing (CN); Haitao Liu, Beijing (CN)

(21) Appl. No.: 18/019,213

(22) PCT Filed: Sep. 15, 2020
(86) PCT No.: PCT/CN2020/115234

§ 371 Date: Feb. 1, 2023

(51) Int. Cl. H01Q 9/04; H01Q 1/24; H01Q 1/48; H01Q 1/52; H01Q 21/06

(52) U.S. Cl. CPC H01Q 9/0414; H01Q 1/246; H01Q 1/48; H01Q 1/523; H01Q 21/065; H04W 88/08

(57) ABSTRACT

The present disclosure provides a base station. The base station includes a PCB board, a multi-function block and at least one antenna element. The multi-function block is located onto the PCB board and configured to cover the PCB board. The at least one antenna element is at least partially embedded inside the multi-function block and attached onto the PCB board.

### TECHNICAL FIELD

The present disclosure generally relates to a technical field of communication industry, more particular to a base station used therein.

### BACKGROUND

Typically, antenna elements and a radome used in a base station are separate from each other. The radome is only used to protect the antenna elements, for example covering or enclosing the antenna elements. Since it is desirable that the radome would not introduce any interference to radiation of the antenna elements, the radome is required to be relatively high, i.e., there is a large space between the radome and the antenna elements. These two separate components, i.e., the antenna elements and the radome cause the base station to be high or thick.

Further, in a lot of base stations (for example radio base stations), radio components and antenna elements are installed together. Especially, it can be seen from 5G network rollout that most of massive MIMO product (AAS, advanced antenna system) has the antenna elements and the radio components mounted together.

In typical designs, one side of a radio PCB board has to be used for antenna radiation. There are a lot of gaps between the radio PCB board and a radio cover, between the antenna elements, between an antenna radome and an antenna PCB board, which are filled with air. The presence of the air is not beneficial to heat dissipation. Even the radio PCB board is of very high heat conductivity; it is still very difficult to efficiently dissipate heat from the side where the antenna elements are located.

That is, in the case that the radio PCB board and the antenna elements are not installed together, the radio components can be cooled at double sides, but when the radio components are mounted with the antenna elements, they only can be cooled from one side. It is impossible to cool them from the other side due to the limitation from the antenna elements and the radome.

### SUMMARY

In view of the foregoing, an object of the present disclosure is to overcome or at least mitigate at least one of above shortcomings in the prior art solution. Herein, the present disclosure provides a new type of the base station.

In accordance with one aspect of the present application, it provides a base station, comprising:
a PCB board;
a multi-function block located onto the PCB board and configured to cover the PCB board; and
at least one antenna element at least partially embedded inside the multi-function block and attached onto the PCB board.

In some embodiments, at least one of the at least one antenna element is a dual functional radiator which is not only an electromagnetic radiator but also a heat radiator.

In some embodiments, each of the at least one antenna element comprises a primary radiator, a secondary radiator and a dielectric material provided between them.

In some embodiments, a conducting pole is provided to connect the primary radiator and the secondary radiator.

In some embodiments, the secondary radiator is located close to a top surface of the multi-function block which is not protruded outside the multi-function block; or the secondary radiator is located onto a top surface of the multi-function block and partially protruded outside the multi-function block.

In some embodiments, the primary radiator is provided onto and in contact with a surface of the PCB board adjacent to the multi-function block.

In some embodiments, the at least one antenna element comprises a plurality of antenna elements separated from each other, and shielding walls are provided between adjacent antenna elements of the plurality of antenna elements.

In some embodiments, at least a part of the shielding walls are lateral walls or longitudinal walls.

In some embodiments, the shielding walls are connected with each other and constitute a shielding net which is configured to divide a body of the multi-function block into a plurality of regions, and each of the regions is provided with one antenna element.

In some embodiments, a heat conducting sheet is provided at a crossing point of the shielding net.

In some embodiments, a top side of the shielding net is provided close to or onto a top surface of the multi-function block and a bottom side of the shielding net is in contact with the PCB board.

In some embodiments, the PCB board is further provided with radio components on a surface of the PCB board far away from the multi-function block.

In some embodiments, the PCB board comprises an antenna layer and a radio layer stacked together, and the at least one antenna element and the radio components are respectively disposed on the antenna layer and the radio layer.

In some embodiments, a grounding plane for heat transferring and shielding is provided between the antenna layer and the radio layer.

In some embodiments, the base station further comprises a heatsink configured to support the PCB board and fix with the multi-function block by a buckle joint, an adhesive agent or a screw.

In some embodiments, the multi-function block is provided with at least one protrusion, and the heatsink is provided with at least one recess, wherein the at least one protrusion is matched with the at least one recess.

In some embodiments, the multi-function block is made of a material having a thermal conductivity which is larger than or equal to 1 W/m·K, and the at least one antenna element is made of metal.

In some embodiments, the shielding walls are made of metal.

In some embodiments, the multi-function block comprises a plurality of multi-function sub-blocks located between the shielding walls.

In some embodiments, the multi-function sub-blocks are inserted into the shielding walls.

### BRIEF DESCRIPTION OF THE DRAWINGS

These aspects and/or other aspects as well as advantages of the present application will become obvious and readily understood from the description of the preferred embodiments of the present application in conjunction with the accompanying drawings below, in which

FIG. 1 is a schematic cross-sectional view of a base station in accordance with an embodiment of the present invention where antenna elements and shielding walls are located within a body of a multi-function block;

FIG. 2A is a schematic top view of the base station as shown in FIG. 1, where the shielding walls are shown to constitute a shielding net;

FIG. 2B is a schematic view of showing the shielding walls in a shape of column walls;

FIG. 2C is a schematic view of only showing the shielding walls in a shape of the shielding net;

FIG. 3A is a schematic view of showing a primary radiator in different shapes;

FIG. 3B is a schematic view of showing a secondary radiator in different shapes;

FIG. 4 is a schematic cross-sectional view of the base station as shown in FIG. 1 with addition of radio components and a heatsink; and

FIGS. 5A and 5B are schematic cross-sectional views of a PCB board in different arrangements.

### DETAILED DESCRIPTION OF EMBODIMENTS

In the discussion that follows, specific details of particular embodiments of the present techniques are set forth for purposes of explanation and not limitation. It will be appreciated by those skilled in the art that other embodiments may be employed apart from these specific details.

Furthermore, in some instances detailed descriptions of well-known methods, structures, and devices are omitted so as not to obscure the description with unnecessary detail.

Embodiments of the present disclosure provide base stations used in the communication industry. Structures and locations of antenna elements, a PCB board and a multi-function block used by the base station and the like are discussed herein and they are improved to transfer heat to the outside efficiently.

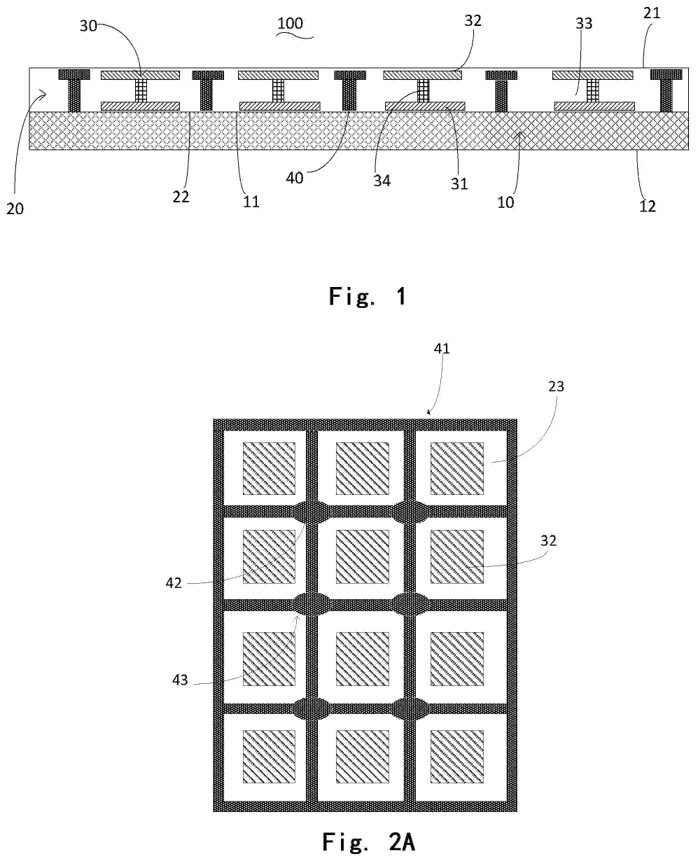

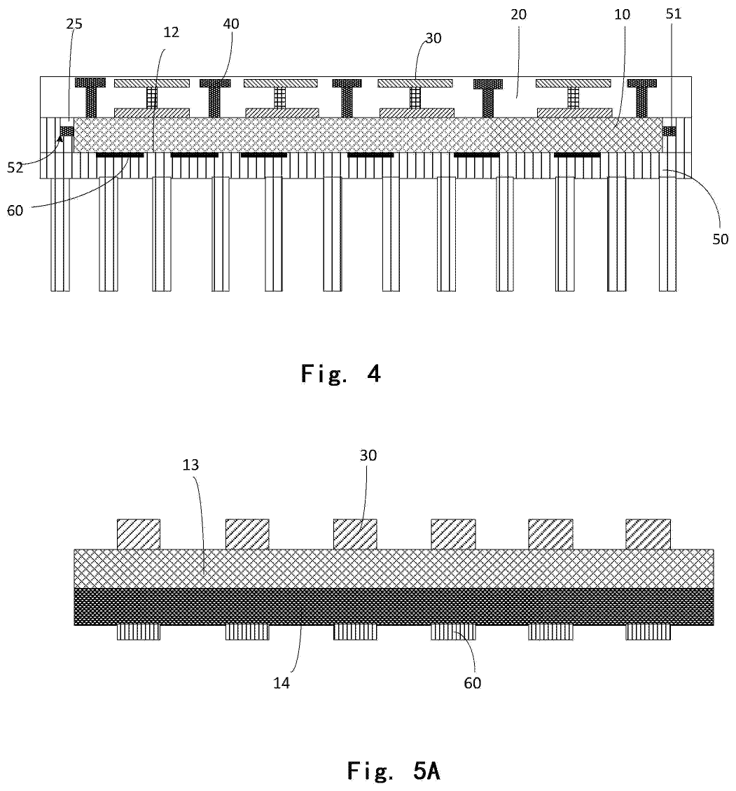

As shown in FIG. 1, it provides a base station 100 including a PCB board 10, a multi-function block 20 and at least one antenna element 30. The PCB board 10 is mounted with the at least one antenna element 30 and radio components 60 which will be discussed with respect to FIG. 4 below. The PCB board 10 can function as an antenna PCB board or as both the antenna PCB board and a radio board which would be used in a typical structural arrangement. In other words, the PCB board 10 can be used to replace the antenna PCB board and the radio board in the traditional base station.

The multi-function block 20 is located onto the PCB board 10 and used to cover the PCB board 10. In one embodiment, the multi-function block 20 is attached onto the PCB board 10 at its bottom surface. Alternatively, some portions of the multi-function block 20 might not be contacted with the PCB board 10, that is, they are not attached entirely.

It should be understood that the multi-function block 20 acts a role as a traditional radome for waterproof and other environment protection (for example providing features for adapting to a windward side design). Further, it can at least help to transfer heat to the outside environment, since the multi-function block 20 is in contact with the PCB board 10 without too much gap or any gap therebetween, and thus this arrangement can facilitate heat transfer by using the multi-function block 20. It can also be used to support the at least one antenna element 30 and help to reduce the thickness of the base station 100. In addition, the multi-function block 20 can be made of materials having a high thermal conductivity and transparent to electromagnetic wave.

In one embodiment, the multi-function block 20 is made of a high thermally conductive plastic materials such as ER008202(DTK22+FR), which is normal plastics with addition materials like ceramic fibers, graphite, boron and so on. It is preferable to use the material having a thermal conductivity larger than or equal to 1 W/m·K. Alternatively, it is easy for the person skilled in the art to use other materials having the similar property to make the multi-function block 20. The present disclosure does not make any limitation on the material of the multi-function block 20.

It should be noted that the multi-function block 20 is used to cover the PCB board 10, but the present invention is not intended to limit a size of the multi-function block 20 with respect to the PCB board 10. The person skilled in the art can select the size of the multi-function block 20 to be larger than, equal to or smaller than that of the PCB board 10. For example, when the base station 100 is designed to be used indoor, the multi-function block 20 might be smaller than the PCB board 10, that is, only some part of the PCB board 10 having important components is needed to be protected by the multi-function block 20.

The at least one antenna element 30 is at least partially embedded inside the multi-function block 20 and attached onto the PCB board 10. It means that the at least one antenna element 30 can be entirely embedded inside the multi-function block 20 without any part protruding outside it, so as to be protected better by the multi-function block 20. Alternatively, the at least one antenna element 30 can also be partially embedded inside the multi-function block 20, that is, a part of the at least one antenna element 30 protrudes outside it, when the protruding part of the antenna element 30 is made of some materials which enables it to be protected by itself without needing the radome or the multi-function block 20. To some degree, this might be beneficial for transferring the heat from the PCB board 10 to the outside environment via the at least one antenna element 30 and/or the multi-function block 20.

Normally, the at least one antenna element 30 includes a plurality of antenna elements separated from each other, for example 4, 8, 16 or more antenna elements. The number of the antenna elements can be chosen according to actual requirements. For sake of convenience, only 4 antenna elements or the similar are shown, but other number of the antenna elements is possible.

As shown in FIG. 1, since the PCB board 10 is used only in the present base station 100 and the antenna elements 30 are directly attached onto the PCB board without any gap therebetween, the antenna elements 30 are dual functional radiators. They are not only electromagnetic radiators but also heat radiators. Their size and shape should be determined by the RF performance, such as S-parameters and radiation patterns. They can be made by metal such as Au, Ag, Cu or other materials having a high thermal conductivity, such as larger than 1 W/m·K. That is, the heat generated on the PCB board 10 can be dissipated through the multi-function block 20 and the antenna elements 30.

It shows that all the antenna elements 30 are entirely embedded within the multi-function block 20. Each antenna element 30 includes a primary radiator 31, a secondary radiator 32 and a dielectric material 33 provided between them. It should be known that the primary radiator 31 and the secondary radiator 32 can be produced with the known methods and structures, so they are not repeatedly discussed herein. However, since the materials of the multi-function block 20 can be plastic, so the material of the dielectric material 33 can be identical with it. Of course, the material of the dielectric material 33 can be different from that of the multi-function block 20.

In an embodiment, a conducting pole 34 is located between the primary radiator 31 and the secondary radiator 32. The conducting pole 34 is used to connect the primary radiator 31 and the secondary radiator 32 within the same antenna element 30. The conducting pole 34 is made of any suitable metal material like copper, gold or the like, and alternatively is made of other materials with a high thermal conductivity. The primary radiator 31 is the main radiator of the antenna element 30, which is fed by the PCB board 10. In other words, the conducting pole 34 can also facilitate the heat transfer from the PCB board 10 to the outside environment.

With the provision of the conducting pole 34, the secondary radiator 32 and the primary radiator 31 can be considered to be one radiator when only a DC current is passing through. When AC current is passing through, they can function as the main radiator and the parasitic radiator respectively.

Furthermore, the conducting pole 34 can also help dissipate heat to the outside through the antenna elements, since the primary radiator 31, the secondary radiator 32 and the conducting pole 34 are all made of materials having a high thermal conductivity.

It can be seen from FIG. 1 that the secondary radiator 32 is located close to a top surface 21 of the multi-function block 10 but not protruded outside it, and the primary radiator 31 is provided onto and in contact with a top surface 11 of the PCB board 10 adjacent to the multi-function block 20. It should be noted that since the multi-function block 20 and the PCB board 10 are contacted at the top surface 11, so the top surface 11 is shown to be identical with a bottom surface 22 of the multi-function block 20.

Alternatively, the secondary radiator 32 can be located onto the top surface 21 of the multi-function block 20. A part of the secondary radiator is protruded outside the multi-function block 20 and the remaining of the secondary radiator 32 is kept within the multi-function block 20. In other words, when the secondary radiator 32 is made of the materials having the waterproof protection or other environment protections, they can be disposed to protrude outside the multi-function block 20. In this way, the heat can be dissipated very efficiently and the size or height of the base station 100 can be optimized.

Further, shielding walls 40 are provided and located between adjacent antenna elements 30. The shielding walls 40 are used to improve isolation between different antenna elements 30. The present disclosure does not have any specific limitation on the location, the size, the shape and the materials of the shielding walls 40.

A top side of the shielding net 41 is provided close to or onto the top surface 21 of the multi-function block 20 and a bottom side of the shielding net 41 is in contact with the PCB board 10 at the bottom surface 22. The shielding net 41 is also helpful to dissipate heat.

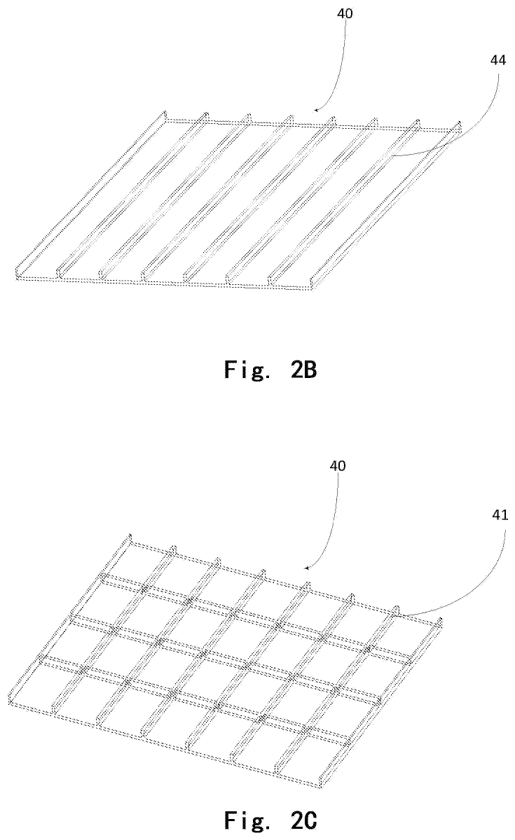

As shown in FIG. 2A, the shielding walls 40 are connected with each other and constitute a shielding net 41. The shielding net 41 divides a body of the multi-function block 20 into a plurality of regions 23. Each of the regions 23 is provided with one antenna element 30. The shielding net 41 is provided with a heat conducting sheet 42 at a crossing point 43 thereof. Because the shielding walls 40 and the heat conducting sheet 42 are made of metal or other materials having a high thermal conductivity, they both function to support the multi-function block 20 and help transfer the heat from the PCB board 10. It should be understood that the heat conducting sheet 42 is circular, oval or any other shape.

In the present invention, the multi-function block 20 and the secondary radiators 32 and the primary radiators 31 are integrated into the volume which should be occupied by the antenna radiators. In this way, the multi-function block 10 would not occupy additional space and reduce the height of the base station 100.

As shown in FIG. 2B, some of the shielding walls 40 are provided to be lateral walls or longitudinal walls 44. That is, the shielding walls 40 can be set to be in a regular pattern, but they can also be in some irregular patterns, which can be chosen by the skilled person in the art.

As shown in FIG. 2C, it only shows the shielding net 41 which is made beforehand. As to this case, the multi-function block 20 can include a plurality of multi-function sub-blocks (not shown) located between the shielding walls 40. That is, the multi-function sub-blocks can be inserted into the shielding walls 40, after the shielding walls 40 are arranged in the shape as shown in FIGS. 2B and 2C.

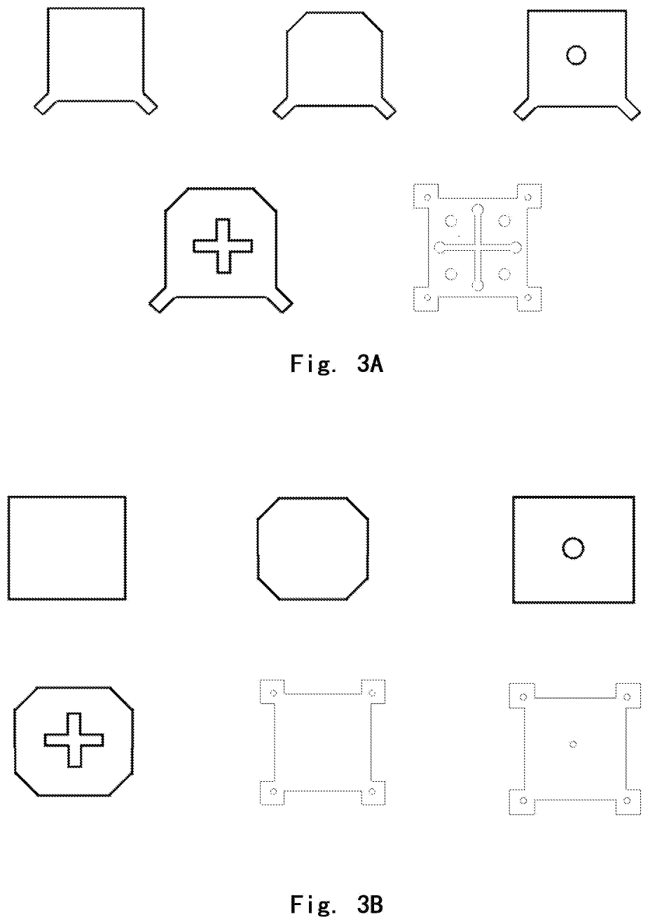

With reference to FIGS. 3A and 3B, the primary radiator 31 and the secondary radiator 32 can be respectively in different shapes. It should be understood that they can be circular, rectangular or other regularly shaped, and alternatively can be other feasible irregular patterns as shown herein.

In combination with FIGS. 2A, 2B and 2C, the primary radiators 31 and the secondary radiators 32 are respectively arranged in a form of an array. It should be noted that the primary radiators 31 and the secondary radiators 32 can also be arranged in any other pattern.

Both of them can be in a round, square, a pentagon shape or any suitable shape. The secondary radiators 32 can be made of any metal or PCB based or printed conducting ink or other conductive materials. The primary radiators 31 can be made of the same materials as that of the secondary radiators 32 or a different material from that of the secondary radiators 32. Alternatively, it is optimal to select some materials having a high thermal conductivity and transparent to the electromagnetic wave for making the primary radiators 31 and the secondary radiators 32. The size and shape of them are typically determined by the RF performance, such as S-parameter and radiation patterns.

As shown in FIG. 4, it shows that the base station 100 also includes a heatsink 50 disposed beneath all the above described components. The heatsink 50 is used to support the PCB board 10, so it is located substantially beneath it. The heatsink 50 and the multi-function block 20 can be fixed together by a buckle joint, an adhesive agent (for example glue 51) or a screw.

It also shows that the PCB board 10 is provided with radio components 60 on a bottom surface 12 of the PCB board 10 far away from the multi-function block 20.

In order to be assembled together, the multi-function block 20 is provided with at least one protrusion 25 and the heatsink 50 is provided with at least one recess 52. As shown, two protrusions 25 are respectively provided at two ends of the multi-function block 20. Accordingly, two recesses 52 are respectively provided at two ends of the heatsink 50. The two protrusions 25 are matched with the two recesses 52.

In an example, a glue 51 is placed in the recess 52 first and then the protrusion 25 is inserted into the corresponding recess 52, so that they are fixed by the glue 51. Other fixing methods are similar in principle so that they are not discussed again.

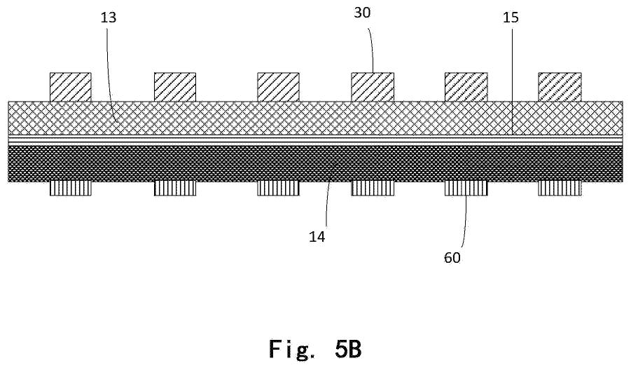

As can be seen from FIG. 5A, the PCB board 10 includes an antenna layer 13 and a radio layer 14 stacked together. The antenna elements 30 and the radio components 60 are respectively disposed on the antenna layer 13 and the radio layer 14.

Further, in FIG. 5B, a grounding plane 15 is provided between the antenna layer 13 and the radio layer 14. The grounding plane 15 is used for heat transferring and shielding. In some embodiments, it can be made of metal and shaped in a layer, so sometimes, it can be called as a shielding and heat transferring layer.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1.-20. (canceled)

21. A base station, comprising:
a PCB board;
a multi-function block located onto the PCB board and configured to cover the PCB board; and
one or more antenna elements attached onto the PCB board, wherein each of the one or more antenna elements is at least partially covered or enclosed by the multi-function block.

22. The base station according to claim 21, wherein at least one of the one or more antenna elements is configured to operate as an electromagnetic radiator and as a heat radiator.

23. The base station according to claim 22, wherein each of the one or more antenna elements includes a primary radiator, a secondary radiator, and a dielectric material disposed between the primary and secondary radiators.

24. The base station according to claim 23, wherein for each of the one or more antenna elements, the primary radiator and the secondary radiator are connected by a conducting pole.

25. The base station according to claim 24, wherein one of the following applies:
the secondary radiator is located close to a top surface of the multi-function block but contained with the multi-function block; or
the secondary radiator is located onto a top surface of the multi-function block and partially protrudes outside of the multi-function block.

26. The base station according to claim 23, wherein the primary radiator is disposed adjacent to the multi-function block and in contact with a surface of the PCB board.

27. The base station according to claim 21, wherein the one or more antenna elements comprises a plurality of antenna elements, and shielding walls are located within the multi-function block between adjacent ones of the plurality of antenna elements.

28. The base station according to claim 27, wherein at least a part of the shielding walls are lateral walls or longitudinal walls.

29. The base station according to claim 27, wherein the shielding walls are connected with each other and constitute a shielding net arranged to divide the multi-function block into a plurality of regions, with each region including a different one of the plurality of antenna elements.

30. The base station according to claim 29, wherein a heat conducting sheet is provided at a crossing point of the shielding net.

31. The base station according to claim 29, wherein a top side of the shielding net is provided close to or onto a top surface of the multi-function block and a bottom side of the shielding net is in contact with the PCB board.

32. The base station according to claim 21, wherein the base station also includes radio components mounted on a surface of the PCB board but away from the multi-function block.

33. The base station according to claim 32, wherein the PCB board comprises an antenna layer and a radio layer stacked together, the one or more antenna elements are disposed on the antenna layer, and the radio components are disposed on the radio layer.

34. The base station according to claim 33, wherein the PCB board includes a grounding plane disposed between the antenna layer and the radio layer, with the grounding plane being arranged for heat transfer and shielding.

35. The base station according to claim 21, wherein the base station further comprises a heatsink arranged to support the PCB board and affixed to the multi-function block by a buckle joint, an adhesive agent, or a screw.

36. The base station according to claim 35, wherein the multi-function block includes at least one protrusion and the heatsink includes at least one recess that matches with the respective at least one protrusion of the heatsink, with the multi-function block and the heatsink being affixed by insertion of the at least one protrusion into the at least one recess.

37. The base station according to claim 21, wherein the multi-function block is made of a material having a thermal conductivity larger than or equal to 1 W/m·K, and the one or more antenna elements are made of a metal.

38. The base station according to claim 27, wherein the shielding walls are made of a metal.

39. The base station according to claim 27, wherein the multi-function block comprises a plurality of multi-function sub-blocks located between the shielding walls.

40. The base station according to claim 41, wherein the multi-function block is a radome arranged to provide protection from an outside environment for the one or more antenna elements and to provide heat transfer from the PCB board to the outside environment.
